(19) United States
(12) Patent Application Publication
(10) Pub. No.: US 2004/0239674 A1
(43) Pub. Date: Dec. 2, 2004

(54) Modeling graphs as XML information sets and describing graphs with XML schema

(75) Inventors: Timothy J. Ewald, Nashua, NH (US); Donald F. Box, Bellevue, WA (US); Keith W. Ballinger, North Bend, WA (US); Stefan H. Pharies, Seattle, WA (US); Martin Gudgin, Sale (GB)

Correspondence Address: RICK D. NYDEGGER, WORKMAN, NYDEGGER & SEELEY, 1000 Eagle Gate Tower, 60 East South Temple, Salt Lake City, UT, 84111, US

(73) Assignee: Microsoft Corporation

(21) Appl. No.: 10/452,696

(22) Filed: Jun. 2, 2003

(51) Int. Cl. G06T 11/20

(52) U.S. Cl. 345/440

(57) ABSTRACT

Systems and methods for modeling graphs as XML information sets and describing them with XML schema. An edge labeled directed graph is converted to an edge labeled directed tree representing some of the edges directly and some of the edges indirectly. A graph is completely traversed such that all nodes are visited and all edges are traversed. Nodes are included by value initially and then by reference. A schema is provided that describes the structure of an XML tree than contains graph data.

### BACKGROUND OF THE INVENTION

1. The Field of the Invention

The present invention generally relates to modeling graph data as directed trees. More particularly, the present invention relates to systems and methods for mapping graphs to and from XML information sets and for describing the XML information sets with an XML schema.

2. Background and Relevant Art

A database generally stores objects that represent some real world subject or event. Each data object typically has relationships with other data objects contained in the same database or in other databases. Objects in the database, for example, often have a parent-child relationship with other objects in the database. Data objects usually have attributes as well. The attributes can be simple types, such as strings or integers, or complex types such as other data objects.

The relationships and attributes of various data objects can be represented graphically as an edge labeled directed graph. Each node of the graph represents a data object in the database. Edges or transitions in the graph represent relationships between the data objects. Additional attribute information about each of the data objects can be stored in the node, as transitions, or in any other appropriate way.

When data from the database is to be presented to a software application for display or manipulation, it is often useful to present the data objects using, for example XML (extensible markup language). XML is a language similar in form to HTML (Hyper Text Markup Language). Unlike HTML, however, XML tags are not predefined. As such, a developer using XML typically defines any tags that are used. To ensure the validity of an XML document, an XML schema definition (XSD) is used to define valid XML tags for the particular XML document.

Describing a graph such as an edge labeled direct graph using XML, however, is a difficult task and various problems arise when using XML information sets to describe edge labeled directed graphs. For example, the cyclic nature of an edge labeled directed graph may create a situation that may require an XML information set of potentially infinite size to describe the directed graph. In other words, a graph may have nodes that have more than one parent node.

To help understand this problem, a sample of a portion of an XML information set describing a graph is set forth below. In this example, the data objects represent individuals and marriage. A marriage data object is associated with a husband data object and a wife data object. Both the husband data object and the wife data object are associated with a child data object. In the sample portion illustrated below, the husband element includes an offspring attribute. The offspring attribute includes a mother attribute. The mother attribute includes an offspring attribute, etc. This leads to a circular representation that could continue indefinitely.

```
<Marriage>
    <husband>
        <name>Don</name>
        <age>40</age>
        <offspring>
            <name>Max</name>
            <age>10</age>
            <offspring xsi:nil=“true”/>
            <mother>
                <name>Barb</name>
                <age>41</age>
                <offspring>
                    <name>Max</name>
                    <age>10</age>
                    <offspring xsi:nil=“true”/>
                        <mother>
                            <name>Barb</name>
                            <age>41</age>
                            <offspring>
                        ...
```

The problem illustrated above is also illustrated in the following XML schema that defines the XML Infoset illustrated above.

```
<xs:schema>
    <xs:complexType name=”Marriage”>
        <xs:sequence>
            <xs:element name=”husband” type=”Person” />
            <xs:element name=”wife” type=”Person” />
        </xs:sequence>
    </xs:complexType>
    <xs:complexType name=”Person”>
        <xs:sequence>
            <xs:element name=”name” type=”xs:string” />
            <xs:element name=”age” type=”xs:int” />
            <xs:element name=”offspring” type=”Person” />
            <xs:element name=”mother” type=”Person” />
            <xs:element name=”father” type=”Person” />
        </xs:sequence>
    </xs:complexType>
</xs:schema
```

While the data types for the elements name and age represent valid data types, namely strings and integers, the data type for the elements offspring, mother and father, namely person, are of a complex data type that is defined by a sequence that uses the very data type it is defining as part of the definition. As such, this creates a situation involving an endless loop and an invalid XML schema definition. Thus, the XML schema that results for cyclic edge labeled directed graphs is not a valid XML schema format.

XML information sets are better suited for describing edge labeled directed tree constructs than for describing edge labeled directed graph constructs. However, if only data objects that can be modeled in edge labeled directed trees can be described by an XML information set, large classes of data would be excluded from many of the data processing and presentation computer programs that are presently available for use with XML information sets or other systems requiring serialized data.

As such, there is a need to map edge labeled directed graphs to edge labeled directed trees such that the data can be represented using XML information sets. Further, there is a need for mapping edge labeled directed trees back to edge labeled directed graphs.

### BRIEF SUMMARY OF THE INVENTION

An XML Information Set (InfoSet) is an abstract data model and typically represents an edge-labeled directed tree. An InfoSet includes a set of elements that have named parent/child relationships and each child element has a bidirectional relationship with one parent. A tree structure can be easily represented in a markup document where the lexical representation of each element appears as a tag inside its parent element and the name of the tag represents the name of the bidirectional relationship. In many applications, data is modeled as an edge labeled directed graph that typically includes a set of nodes with arbitrary named relationships. The nodes can be connected to any number of other nodes. The present invention relates to a schema for describing an Infoset that contains graph data, to converting a graph into a tree and vice versa, and to a schema pattern that uses the schema.

In the XML schema, each type of graph node is modeled as an XML Schema complexType that has certain characteristics. A type's element content is optional, the type has an optional attribute reference to the global ID attribute, and the type has an optional attribute reference to the global REF attribute (the serialization of this attribute is typically lower case). When a graph is converted or mapped to a tree, each node is first included by value and when that node is encountered again during a traversal of the graph, the node is typically included by reference.

To convert a graph to a tree, an empty table for storing pairs is constructed. Pairs stored in the table represent certain nodes of the graph. As the graph is traversed, the table is consulted to determine if a particular node has been encountered before. If the node is not in the table, the node is inserted in the tree and a new pair is added to the table. The data of the node is stored in the tree in some form. This node is included by value. If a node is in a pair stored in the table, an element in the tree is marked with a global REF attribute that uses an ID of the node as found in the table. If a transition or edge does not lead to a node, then the element is marked with a nil attribute.

To convert a tree to a graph, an empty table for storing pairs is also constructed. The global ID attribute, global REF attribute, global NIL attribute, and/or the absence of these three attributes determine how the graph is constructed. A global ID attribute results in a new node in the graph and a new pair in the table. A global REF attribute typically results in a transition to a node that already exists in the graph. The global NIL attribute results in a null reference being placed in the graph. The absence of these attributes indicates that the transition in the tree does not lead to a node but to data that should be stored in a node. The data is placed in the appropriate node in the graph.

Additional features and advantages of the invention will be set forth in the description which follows, and in part will be obvious from the description, or may be learned by the practice of the invention. The features and advantages of the invention may be realized and obtained by means of the instruments and combinations particularly pointed out in the appended claims. These and other features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features of the invention can be obtained, a more particular description of the invention briefly described above will be rendered by reference to specific embodiments thereof which are illustrated in the appended drawings. Understanding that these drawings depict only typical embodiments of the invention and are not therefore to be considered to be limiting of its scope, the invention will be described and explained with additional specificity and detail through the use of the accompanying drawings in which:

FIG. 1 illustrates one embodiment of an edge labeled directed graph;

FIG. 2 illustrates one embodiment of an edge labeled directed tree;

FIG. 3 represents one embodiment of an edge labeled directed graph before being mapped to an edge labeled directed tree;

FIG. 4A through 6B illustrate an exemplary method for converting a graph to a tree.

FIG. 7 illustrates one embodiment of a tree that results from a conversion of the graph illustrated in FIG. 3;

FIGS. 8A through 10B illustrate an exemplary method for converting the tree of FIG. 7 back into the graph of FIG. 3; and

FIG. 11 illustrates the graph mapped from the tree of FIG. 7.

### DETAILED DESCRIPTION OF THE PREFERRED EMBODIMENTS

Many software applications work with XML and rely on XML information sets (Infosets) as a data model. Unfortunately, much of the information processed by these software applications is inherently a graph. For example, data objects in databases, data represented in programming languages, and the like are examples of data that can be inherently represented as graphs. The present invention relates to systems and methods for modeling graphs as XML Infosets and to describing these XML Infosets with an XML schema. More particularly, the present invention relates to systems and methods for mapping an edge-labeled directed graph to an edge-labeled direct tree which can be easily represented in an XML format and vice versa.

Mapping graphs to XML Infosets provides extrinsic support for graphs in XML Schema. Advantageously, methods for mapping graphs to trees enables the development of software that can solve a wide range of development-time and run-time problems such as, for example, generating programming language source types for representing the graph a tree contains and for converting an XML message containing a tree directly to a graph of programming language specific objects.

Typically, an Infoset model is an edge or transition-labeled directed tree that includes a set of elements that have named parent/child relationships. Each child element has a bidirectional link to exactly one parent. A tree is easy to represent in a markup document as the lexical representation of each element appears as a tag inside its parent element. The name of the tag represents the name of the relationship.

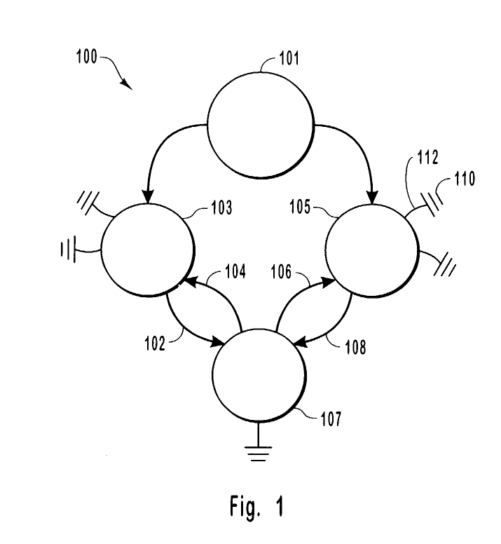

FIG. 1 illustrates one example of a cyclic edge-labeled directed graph. This example of an edge labeled directed graph includes nodes, transitions, and null references. In this example, nodes 103 and 105 are children of the parent node 101. Node 107 is a child of the nodes 103 and 105. Additionally, nodes 103 and 105 are also children of the node 107, as illustrated by the transitions 104 and 106.

The null reference 110 represents a situation where the data object represented by the node 105 is not related to another node through the relationship described by the transition 112. The graph 100 represents graphs that can include a set of any with arbitrarily named relationships. Each node in the graph can be connected to any number of other nodes in the graph. One of skill in the art can appreciate that the presented invention can be applied to other graphs of various configurations from the discussion below.

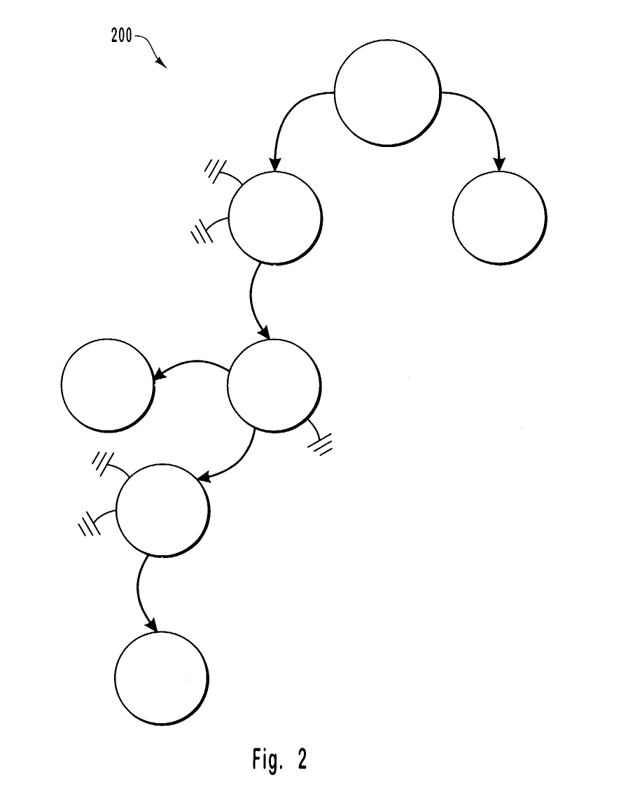

FIG. 2 illustrates an example of a edge labeled directed tree 200. The edge directed tree 200 also includes nodes (also referred to as elements), transitions, and null references. However, FIG. 2 illustrates an edge labeled directed tree because each child element has a single parent. One embodiment of the present invention maps a graph such as the graph illustrated by FIG. 1 into a tree such as the tree illustrated by FIG. 2 and vice versa.

In addition to converting or mapping a graph to/from a tree, the present invention also provides a data structure that describes an edge labeled directed tree that contains graph data. In this example, the data structure is an XML schema. In the XML schema, each type of graph node type is modeled as an XML Schema complexType that has the following characteristics. The element content of a type is optional. In other words, the compositor defining the element children of the complexTypes has a minimum occurrence constraint of zero (0). Next, the type has an attribute reference to the global ID attribute that is optional. Thus, the attribute reference's use constraint is optional. Also, the type has an attribute reference to a global ref attribute that is optional. The attribute reference's use constraint is optional. When a complexType representing a node type is used, the element declaration may be marked as nil. The element declaration's nil attribute may be true.

An XML schema as described above overcomes the problems previously described. This is achieved because nodes are included by value and then by reference. Including certain nodes by reference retains the graphical nature of the data objects while permitting the graph to be represented as a tree that can be expressed using, for example, XML.

One embodiment of the present invention models graph nodes as elements in an Infoset. The elements contain data and are uniquely identified using, for example, a standard XML/XSD ID mechanism. Each node of the graph is included by value. References to nodes can also be modeled as elements that do not contain data and that refer to an existing node using, for example, the standard XML/XSD IDREF mechanism. In other words, some nodes of the graph are included by reference in addition to being included by value. This ensures that each node of a graph is included in an XML Infoset by value before it is included by reference.

Converting a graph such as an edge-labeled directed graph to an edge-labeled directed tree begins by constructing a table that is initially empty. The table contains {unique ID, node reference} pairs. Next, each transition or edge in the graph is traversed until every node of the graph is visited at least once. When a transition or edge is traversed, a new element is added to the tree and the name of the element is the same as the name of the transition or edge. If a traversed transition or edge leads to a node, then it is not a null reference.

As the graph is traversed, the table is searched to determine if the node that a transition leads to is present in the table. If the node of the graph is not in the table, then the following occurs. The node is assigned a unique ID and a new pair is added to the table. The element representing the edge that leads to the node is marked with a global ID attribute having a value that is the unique ID of the node. The data contained in the graph node is stored in the tree element and the directed edges leaving the graph node are traversed. Thus, the graph node is included by value.

If the node is in the table, then the following occurs. The element representing the edge that led to the node is marked with a global ref attribute whose value is the unique ID of the node as found in the table of pairs and the directed edges leaving the node are not traversed. In this case the nodes are included in the tree by reference.

If a traversed edge does not lead to a graph node, it is a null reference. In this case, the element representing the edge is marked with a global nil attribute whose value is true and there are no directed edges to traverse. The above actions are performed repeatedly until all nodes can be found in the pairs in the table and there are no more edges or transitions to traverse in the graph being mapped or converted to a tree.

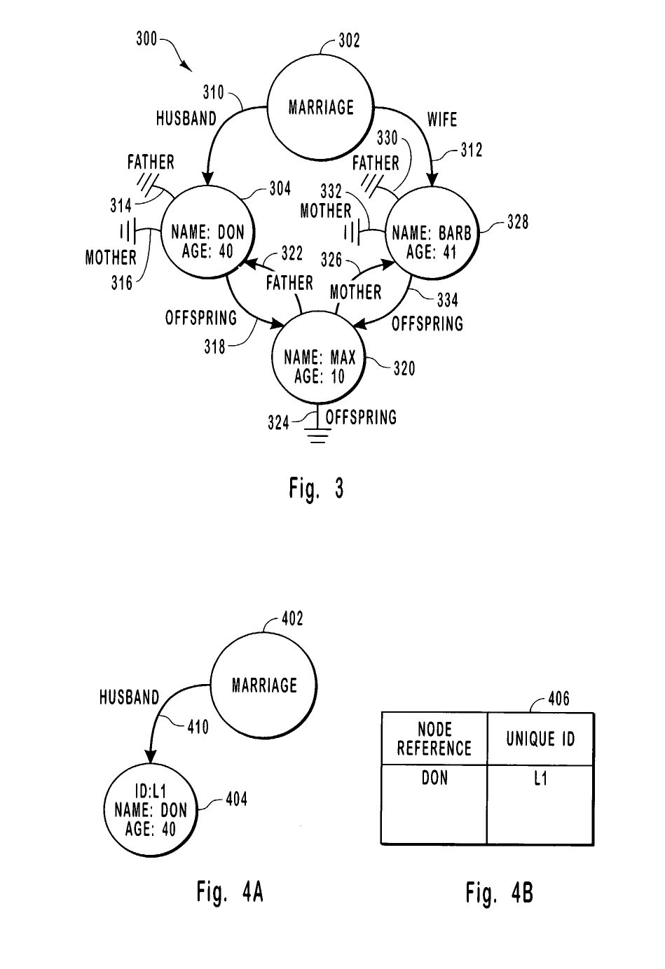

FIGS. 3 through 7 illustrate one embodiment of the present invention for mapping an edge-labeled directed graph to an edge labeled directed tree. The edge labeled directed tree can be expressed in, for instance, an XML document. FIG. 3 shows an edge labeled directed graph 300 with a node 302 labeled marriage. Two transitions, a transition 310 labeled husband and a transition 312 labeled wife, leave the node 302 labeled marriage. The transition 310 leads to a node 304 with a name attribute of Don and an age attribute of 40. The node 304 has three transitions 314, 316, and 318 leading away from it. The transition 314 is labeled father, the transition 316 is labeled mother, and the transition 318 is labeled offspring.

For ease of explanation, it will be assumed that the node 304 is not related to any other node through its father and mother transitions 314 and 316 and as such those transitions point to null references. The offspring transition 318 leads to a node 320 that has a name attribute of Max and an age attribute of 10. The node 320 is of type person and therefore has the transitions associated with it of father, mother and offspring just as the node 304 also has similarly labeled transitions associated with it because the node 304 is also of type person.

The transition 322 labeled father from the node 320 leads to the node 304. There are no other nodes related to the node Max through the transition 324 and thus the offspring transition 324 points to a null reference. The transition 326 labeled mother leads to a node 328 with a name attribute of Barb. The node 328 is of type person and thus has name and age attributes, and transitions labeled father, mother and offspring. As with the node 304 named Don, for ease of explanation, the father and mother transitions 330 and 332 leading from Barb do not relate to any other nodes and thus point to null references. The transition 334 labeled offspring from the node 328 leads to the node 320 named Max.

To convert an edge labeled directed graph such as that shown in FIG. 3 to an edge-labeled directed tree using one embodiment of the present invention, each transition or edge in the graph 300 is traversed until every node in the graph 300 has been visited at least once and there are no more transitions to traverse. The graph 300 can be traversed in any manner that ensures that each node is visited at least once and that all transitions or edges are traversed.

As the graph 300 is traversed, a table containing {unique ID, node reference} pairs is constructed. Initially this table may be empty. As nodes in the graph are visited for the first time, elements are added to the tree and the nodes are indexed in the table with their unique ID. For purposes of this discussion, an element in a tree represents the name of the transition as well as any information stored in the node to which the transition points. Further, items contained in the tree node are also elements that may belong to other elements. When each transition in the graph is traversed, there are two possible outcomes: the traversed edge leads to a graph node or the traversed edge leads to a null reference.

If the traversed edge leads to a graph node, there are two further possible outcomes, namely that the graph node will be referenced in the {unique ID, node reference} table and has already been visited, or it will not be referenced in the {unique ID, node reference} pairs table and has not yet been visited. If the graph node is not in the table, the node is assigned a unique ID and a new {unique ID, node reference} pair is added to the table; the element representing the transition that leads to the node is marked with a global ID attribute whose value is the node's unique ID; the data contained in the graph node is stored in the tree element in some form (the details are problem or domain specific) and the transitions or edges leaving the graph node are traversed.

If the graph node is in the table the element representing the edge that led to the node is marked with a global Ref attribute whose value is the node's unique ID, as found in the table of {unique ID, node reference} pairs; and the directed edges leaving the graph node are not traversed. In one embodiment of the invention, the table of {unique ID, node reference} pairs may be eliminated if the hardware that the embodiment is being implemented on supports fixed memory addresses for storing the graph data. In this case, the memory location can be used as the unique ID.

If the traversed transition leads to a null reference, the element representing the transition is marked with a global nil attribute whose value is set to true. No transitions are traversed from the null reference as they do not exist. The process of traversing transitions in the graph continues until all the nodes can be found in the {unique ID, node reference} table and there are no more transitions or edges to traverse.

FIGS. 4-7 illustrate one embodiment of a method for converting the graph of FIG. 3 into a tree. As the graph illustrated in FIG. 3 is traversed and nodes are encountered, FIGS. 4A-7 illustrate the development or construction of the corresponding tree. The first node visited in a traversal of the graph 300 shown in FIG. 3 is the marriage node 302. One of the transitions associated with the marriage node 302 is then traversed, namely the transition 310 is traversed to visit the node 304 named Don. Any order of traversing the transitions can be employed so long as all of the transitions are traversed. In this example, a top down left to right traversal is used to ensure that each transition is traversed and each node is visited. As previously stated, a table of pairs is created before the graph is traversed and the table of {unique ID, Node reference} pairs is then searched to see if the node 304 named Don is present. Because the node 304 named Don does not appear in the table yet, the node 304 is assigned a unique ID such as in this example, “L1” and the {unique ID, node reference} pair is added to the table as illustrated as table 460 in FIG. 4B. As such, an element marriage 402 is added as a node to the directed tree, a transition 410 labeled husband is added to the tree that leads to the node 404. The node 404 has an ID attribute L1, a name attribute of Don and an age attribute of 40 and is added to the tree as shown in FIG. 4A.

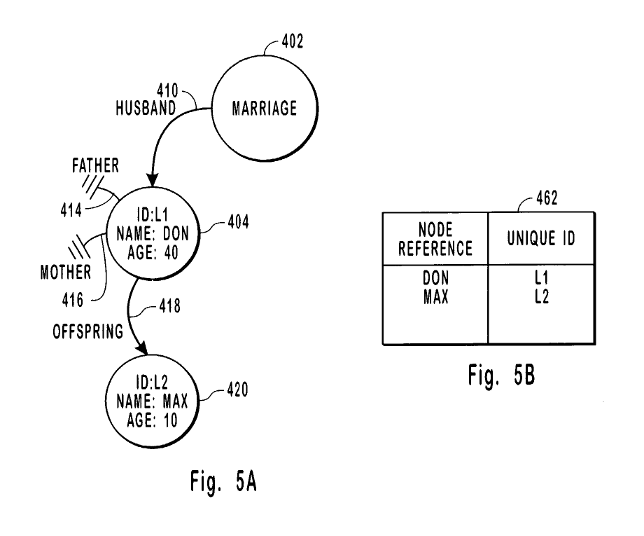

FIG. 5A shows the traversal of transitions leaving the node 304 named Don in the edge labeled directed graph 300 of FIG. 3. Traversal of the transition 314 labeled father does not lead to a node and thus there is no need to search the table or add additional elements other than a null reference (representing a nil=true global attribute) and a transition 414 labeled father to the directed tree. A similar analysis is conducted for the transition labeled mother leading from the node 304 named Don resulting in the transition 416.

The transition 318 labeled offspring from the node 304 named Don leads to a node 320 named Max on the graph 300. As such, the table of FIG. 4B is searched for a reference for the node 320 named Max. When such an entry is not found, an entry is created wherein the node 320 is associated with a unique ID, in this case L2 as shown in the table 462 in FIG. 5B. Various elements are then added to the tree such as a transition 418 labeled offspring from the node 404. A node 420 connected to the offspring transition 418 is created and given an ID attribute of L2, a name attribute of Max and an age attribute of 10.

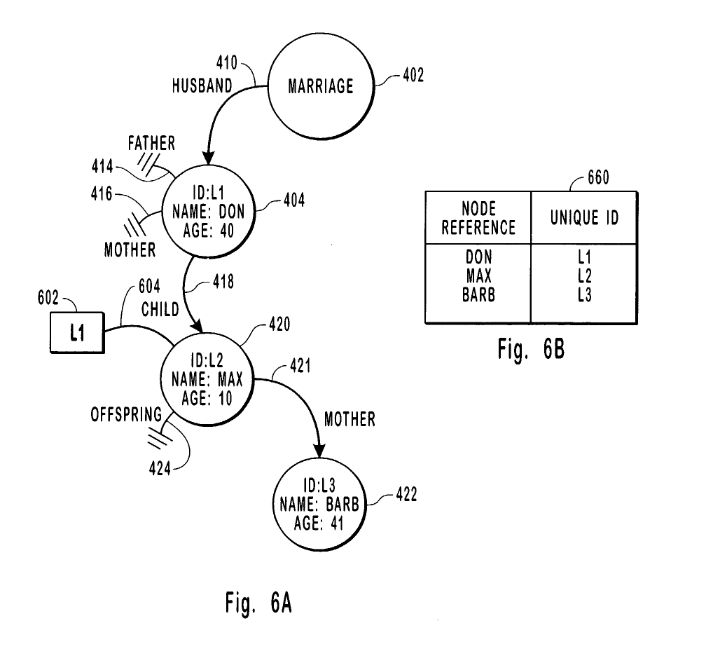

FIG. 6A shows the additions to the directed tree resulting from the traversal of transitions leading from the node 320 named Max. One of the transitions leading from Max is the transition 322 labeled father. In the graph 300, the transition 322 leads to the node 304 named Don. Thus, the table of FIG. 5B is searched for the node named Don. In this case, an entry appears in the table for the node 304 named Don. As such, an element representing the transition that led to the node 304 is added to the tree as a transition 604 and an element 602 marked with a global reference attribute whose value is the unique ID (L1) of the node 304 as found in the table of {unique ID, node reference} pairs is added to the tree. Any element that has been placed in the tree as a reference attribute does not have any transitions leading from it.

The transition 324 labeled offspring from the node 320 leads to a null reference. A transition 424 labeled offspring that points to a null reference is therefore added to the tree. In the present example, the next transition that is traversed is the transition 326 labeled mother from the node 320. The table of FIG. 5B is searched for the node labeled Barb. Because the node 328 named Barb does not appear in the table 462, a unique ID is assigned to the node 328 named Barb, L3, and a reference pair is added to the table as shown in the table 660 in FIG. 6B. Additionally, tree elements in the form of a transition 421 labeled mother and a node 422 with a ID attribute of L3, a name attribute of Barb and an age attribute of 41 are added to the tree as shown in FIG. 6A.

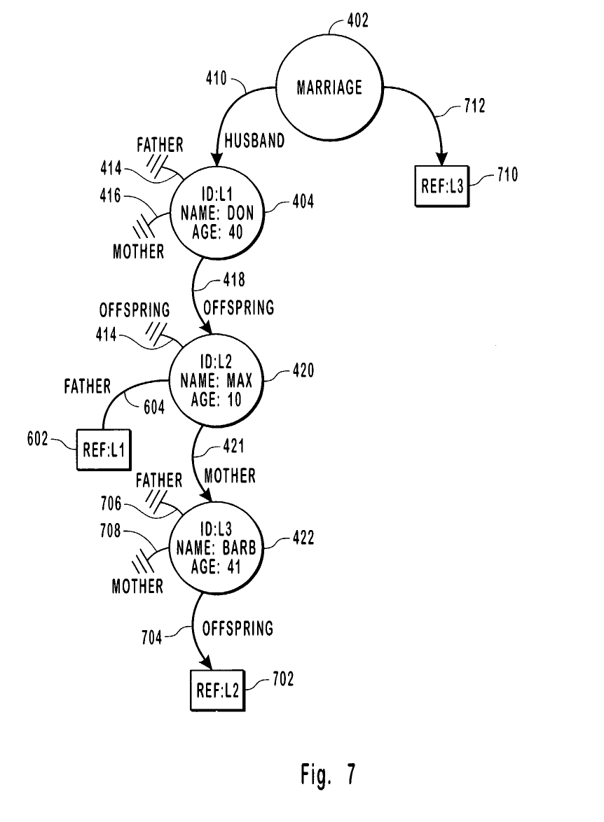

In FIG. 7, the transitions 330 and 332 labeled father and mother respectively from the graph node 328 are sequentially traversed, but as they both lead to null references, transitions 706 and 708 labeled father and mother respectively are added to the tree and also connect to null references. A transition 334 labeled offspring from the node 328 is traversed. This node points to the node 320 in the edge-labeled directed graph. As such, the table 660 (in FIG. 6B) is searched for the node 320. The node 320 appears in the table with the reference ID L2. As such, a transition 704 is added to the tree of FIG. 7 and an element 702 is marked with a reference attribute of L2.

Next, a transition 312 labeled wife from the node 302 labeled marriage is traversed. In the edge-labeled graph this transition points to the node 328 named Barb. Therefore, the table is searched for the node 328. Because the node 328 appears in the table, a transition 712 is added to the tree of FIG. 7 that leads to an element 710 with a reference attribute L3 (710) that correlates to the node 328.

In one embodiment, each transition of the tree in FIG. 7 can be represented as an XML element. The tree nodes or the information in the tree nodes can also be represented as XML elements. An XML document, with the WRT namespaces removed, for the particular instance of marriage shown in FIG. 7 is as follows.

```
<Marriage>
    <husband g:ID=“L1”>
        <name>Don</name>
        <age>40</age>
        <offspring g:ID=“L2” >
            <name>Max</name>
            <age>10</age>
            <offspring xsi:nil=“true”/>
            <mother g:ID=“L3” >
                <name>Barb</name>
                <age>41</age>
                <offspring g:Ref=“L2” />
                <mother xsi:nil=“true” />
                <father xsi:nil=“true” />
            </mother>
            <father g:Ref=“L1” />
        </offspring>
        <mother xsi:nil=“true” />
        <father xsi:nil=“true” />
    </husband>
    <wife g:Ref=“L3”>
    </wife>
</Marriage>
```

As such, an edge labeled directed graph is mapped to edge-labeled directed tree. This edge-labeled directed tree can then be represented in XML format as illustrated above. An XML schema definition (XSD) for the “type” marriage in the above example is as follows.

```
<xs:schema>
    <xs:complexType name=”Marriage”>
        <xs:sequence minOccurs=”0” >
            <xs:element name=”husband” type=”Person” />
            <xs:element name=”wife” type=”Person” />
        </xs:sequence>
        <xs:attribute Ref=”g:ID” use=”optional” />
        <xs:attribute Ref=”g:Ref” use=”optional” />
    </xs:complexType>
    <xs:complexType name=”Person”>
        <xs:sequence minOccurs=”0” >
            <xs:element name=”name” type=”xs:string” />
            <xs:element name=”age” type=”xs:int” />
            <xs:element name=”offspring” type=”Person” />
            <xs:element name=”mother” type=”Person” />
            <xs:element name=”father” type=”Person” />
        </xs:sequence>
        <xs:attribute Ref=”g:ID” use=”optional” />
        <xs:attribute Ref=”g:Ref” use=”optional” />
    </xs:complexType>
</xs:schema>
```

In some embodiments, certain rules may apply in the use of a schema as illustrated above. For example, the XML schema set forth above defines a Person complex data type. The Person data type may, but is not required to (because minOccurs=“0”) include an element content sequence that includes name, age, offspring, mother and father elements. The Person data type may, but does not need to (because the ID attribute is optional), include a global ID attribute. The Person data type may, but does not need to (because the Ref attribute is optional), include a Ref attribute. In one embodiment, either the ID attribute or the Ref attribute but not both is used for each instance of a data object in the XML document. When the ID attribute is used, the element content sequence that includes name, age, offspring, mother and father elements may be used. When the Ref attribute is used, the element content sequence is not used. When the Ref attribute is used, other information about the data object it represents can be discovered by finding the data object with the ID attribute that corresponds to the Ref attribute.

The present invention also converts or maps a tree to a graph. This method also begins by constructing a table containing {unique ID, node reference} pairs. The table may be empty initially. Each of the transitions or edges of the tree is then traversed until every tree node (or element) is visited at least once. When a transition is traversed, the element that it leads to is examined and there are four possible outcomes. The tree element may have a global ID attribute that identifies a graph node directly, the tree element may have a global reference attribute that identifies a graph node indirectly and has no other attributes, the tree element may have a global nil attribute that represents a null reference and no other attributes, or the tree element may have none of these global attributes.

If the tree element has a global ID attribute that identifies a node directly, a new graph node is constructed; a new {unique ID, node reference} pair is added to the table; the data contained in the element is stored in the new graph node in some form (the details are problem and domain specific) and the new graph node is attached to a directed edge that has the same name as the tree element and is leaving the graph node identified by the tree element's parent element.

If the tree element has a global reference attribute that identifies a graph node indirectly, a reference to the graph node is retrieved from the table of {unique ID, node reference} pairs using the value of the tree elements reference attribute as a key; and the referenced graph node is attached to a directed edge that has the same name as the tree element and is leaving the graph node identified by the tree elements parent element.

If the tree element has a global nil attribute that represents a null reference, a null reference is attached to a directed edge that has the same name as the tree element and is leaving the graph node identified by the tree elements parent element.

If the tree element has none these global attributes, the element does not represent a directed edge that leads to a graph node, but the data stored in a graph node. This element will be processed with its closest ancestor element that is marked with a global ID attribute.

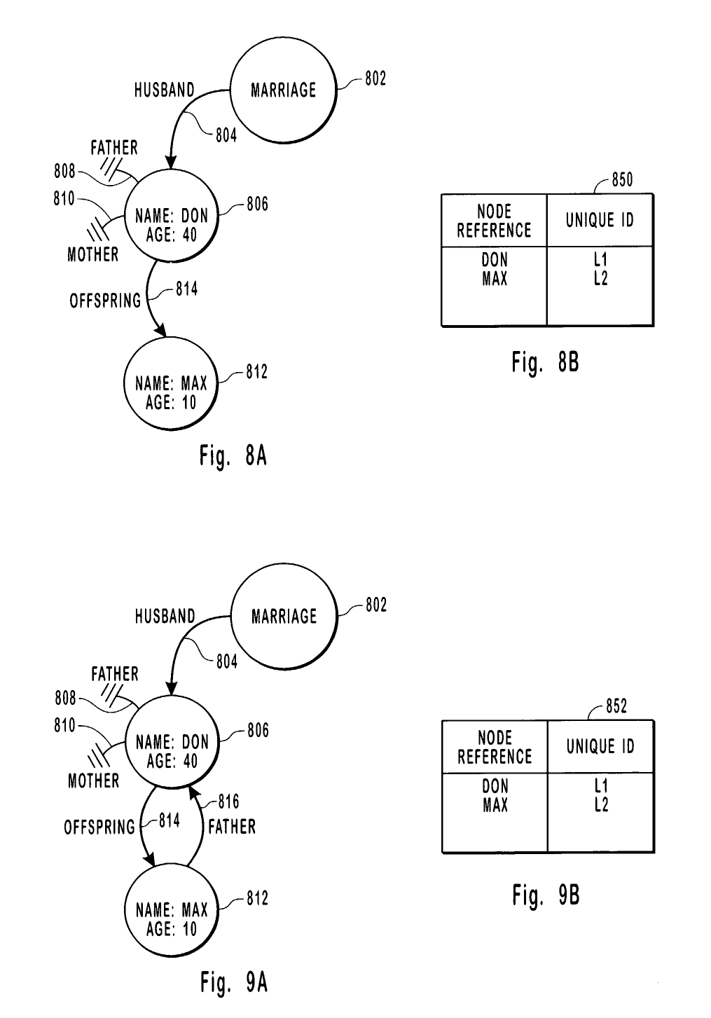

FIGS. 8A through FIG. 11 illustrate an exemplary process of converting the tree of to an edge labeled directed graph. The transition 410 labeled husband leading from the node 402 labeled marriage is traversed. The transition element 410 leads to a node that is labeled with an ID reference, namely L1. In FIG. 8A, node 802 labeled marriage is constructed on the edge labeled graph, a transition 804 labeled husband leading from the node 802 labeled marriage is constructed and a node 806 with a name attribute of Don is connected to the husband transition 804. The elements representing the name Don and the age 40 are represented as attributes in the node 806. Also, a node reference pair is added to the {unique ID, node reference} table that correlates with the node 806 as shown in FIG. 8B.

The transitions leading away from the tree node 404 are then traversed. Because the transitions labeled father and mother point to global nil references, transitions labeled father (808) and mother (810) pointing to null references are constructed on the graph as shown in FIG. 8A. The transition 418 labeled offspring directed from the node 404 is then traversed. The transition 418 leads to a node 420 with an ID reference of L2, a name attribute of Max and an age attribute of 10. Therefore, a node 812 with a name attribute of Max and an age attribute of 10 is added to the graph as shown in FIG. 8A. Additionally, an entry is made in the { unique ID, node reference} table for the node 812 labeled Max correlating the node with a unique ID from the tree node element as illustrated in the table 850 of FIG. 8B.

FIG. 9A illustrates the result of traversing the transitions from the node 420 with the ID attribute L2 of the tree in FIG. 7. The offspring transition 424 of the edge tree from the node with the ID attribute L2 points to a nil reference such that a transition 818 labeled offspring pointing to a null reference is added to the graph as shown in FIG. 9A. The transition 604 labeled father directed from the node with the Ref attribute ID L2 is then traversed. Traversing this transition leads to an element 602 with a reference attribute of L1. Consulting the table of FIG. 9B reveals that L1 correlates with a node reference attribute of Don. Therefore a transition 816 is constructed on the graph leading from the node 812 named Max to the node 806 named Don.

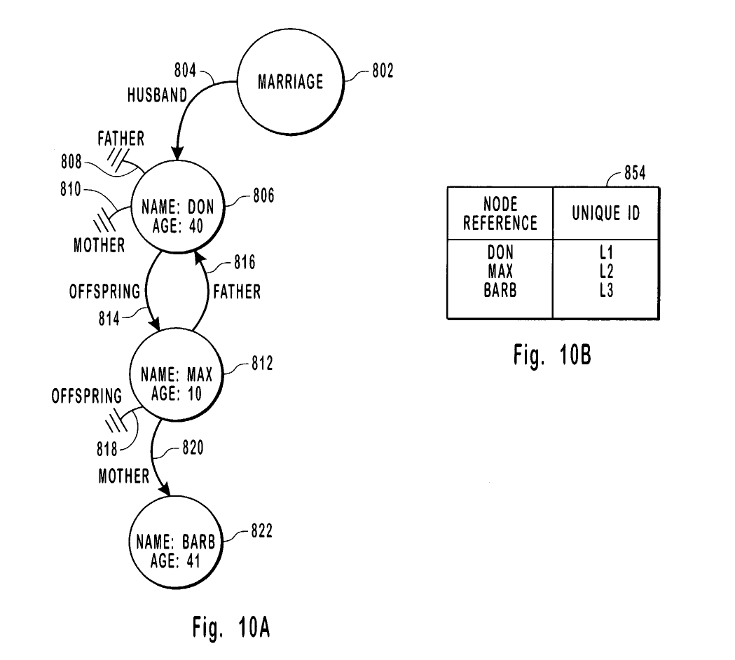

The transition of the edge labeled directed tree leading away from the node 420 with the ID attribute L2 is then traversed. This transition leads to a node 422 with an ID attribute L3, a name attribute Barb and an age attribute 41. As such, a transition 820 labeled mother is added to the graph as shown in FIG. 10A directed away from the node 812 named Max to a node 822 named Barb with an age attribute of 41. An entry is then made in the table correlating Barb to the ID attribute L3 as shown in the table 854 of FIG. 10B.

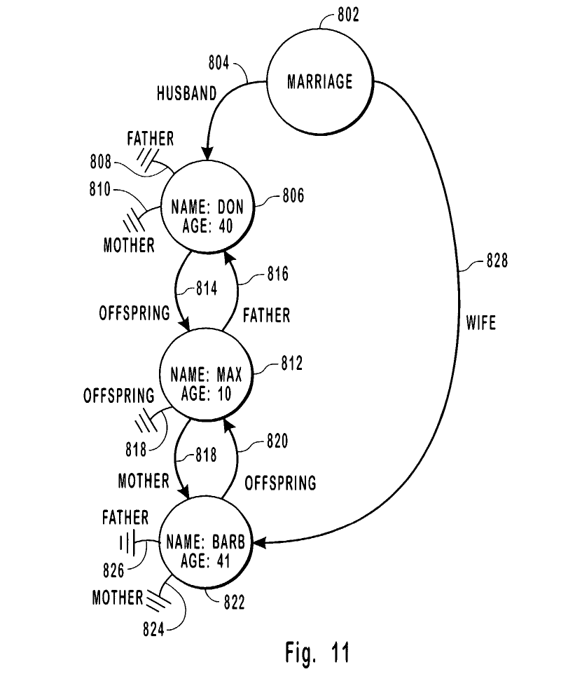

FIG. 11 illustrates the results of traversing the transitions directed away from the node 822 with the ID attribute L3 of the edge labeled directed tree. Both the father and mother transitions 706 and 708 directed away from the node 422 with the ID attributes L3 point to nil global references. Therefore transitions 826 and 824 labeled father and mother are added to the graph as shown in FIG. 11 from the node 822 named Barb to null references. Traversing the transition labeled offspring from the node 422 of the edge labeled directed tree leads to an element 702 with a reference attribute L2. Thus the {unique ID, node reference} table is consulted where it is discovered that the reference L2 correlates with the node 420 named Max. Therefore, a transition 820 is constructed on the edge labeled directed graph labeled offspring away from the node 822 to the node 812.

Next, the transition 712 labeled wife from the node 402 of the edge labeled directed tree is traversed. This action leads to an element 710 with a reference attribute of L3. Therefore the {unique ID, node reference} table is consulted where is discovered that L3 correlates with the node labeled Barb. As such a transition 828 labeled wife directed away from the node 802 to the node 822 is constructed on the edge labeled directed graph illustrated in FIG. 11. As such, an edge labeled directed tree of FIG. 7 is mapped back to an edge labeled directed graph of FIG. 11.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method for converting a graph to a tree, the method comprising:
traversing a graph having a plurality of nodes and a plurality of transitions that connect the plurality of nodes such that each node is visited at least once and each transition is traversed; and
during a traversal of the graph:
including a particular node of the graph in a tree by value if the particular node has not been visited before; and
and including the particular node of the graph in the tree by reference if the particular node has been visited before.

2. A method as defined in claim 1, further comprising constructing a table for storing node pairs, wherein each node pair includes a unique ID and a node reference.

3. A method as defined in claim 2, wherein including a particular node of the graph in a tree by value if the particular node has not been visited before further comprises determining that a node pair for the particular node is not in the table.

4. A method as defined in claim 2, wherein including a particular node of the graph in a tree by value if the particular node has not been visited before further comprises:
adding a node pair for the particular node to the table; and
marking a transition that led to the particular node with a global ID attribute having a value equal to the unique ID of the particular node.

5. A method as defined in claim 4, further comprising:
traversing transitions leaving the particular node; and
storing data contained in the graph node in a tree element.

6. A method as defined in claim 2, wherein including the particular node of the graph in the tree by reference if the particular node has been visited before further comprises determining that a node pair for the particular node is in the table of nod e pairs.

7. A method as defined in claim 6, wherein including the particular node of the graph in the tree by reference if the particular node has been visited before further CD comprises:
marking an element that represents the transition that led to the particular node with a global REF attribute having a value equal to a unique ID of the particular node as stored in the table; and
not traversing transitions leaving the particular node.

8. A method as defined in claim 1, further comprising marking an element that represents a transition that does not lead to any node with a nil attribute whose value is true.

9. A method for converting a graph to a tree, the method comprising:
creating a table for storing pairs that is initially empty, wherein each pair includes a unique ID and a node reference for a node;
during a traversal of a graph, determining if a particular transition leads to a node that is already represented in the table by a particular pair;
if the node is not represented in the table by a particular pair then:
assigning a unique ID to the node;
adding a new pair to the table, wherein the new pair includes the unique ID and a node reference to the node; and
marking an element that represents the particular transition with a global ID whose value equals the unique ID of the node; and
if the node is represented in the table, then marking the element representing the particular transition with a global ref attribute whose value is the unique ID of the node as represented in the pair in the table.

10. A method as defined in claim 9, wherein marking an element that represents the particular transition with a global ID whose value equals the unique ID of the node further comprises storing data contained in the node in a tree element.

11. A method as defined in claim 10, wherein marking an element that represents the particular transition with a global ID whose value equals the unique ID of the node further comprises traversing directed edges leaving the node.

12. A method as defined in claim 9, wherein marking the element representing the particular transition with a global ref attribute whose value is the unique ID of the node as represented in the pair in the table further comprises not traversing transitions that leave the node.

13. A method as defined in claim 9, further comprising marking an element of the tree representing an edge that does not lead to a graph node with a global nil attribute having a value of true.

14. A method as defined in claim 9, further comprising representing the tree in XML.

15. A method as defined in claim 14, further comprising converting the tree represented in XML to a graph.

16. A method for converting a tree to a graph, the method comprising:
constructing a table for storing pairs that is initially empty, wherein each pair includes a unique ID and a node reference;
while traversing a particular transition in a tree, examining a particular element led to by the particular transition;
constructing a new graph node if a particular tree element has a global ID attribute that identifies a graph node directly;
if the particular tree element has a global REF attribute that identifies a graph node indirectly, then attaching a referenced graph node to a directed edge that has a name that is the same as a name of the particular tree element;
if the particular tree element has a global nil attribute then attaching a null reference to the directed edge that has the same name as the particular tree element; and
if the particular element does not have the global ID attribute, the global REF attribute or the global nil attribute, then the particular element does not lead to a graph node.

17. A method as defined in claim 16, wherein constructing a new graph node if a particular tree element has a global ID attribute that identifies a graph node directly further comprises adding a new pair to the table that corresponds to the particular tree element.

18. A method as defined in claim 16, wherein constructing a new graph node if a particular tree element has a global ID attribute that identifies a graph node directly further comprises storing data contained in the particular element in the new graph node.

19. A method as defined in claim 18, wherein constructing a new graph node if a particular tree element has a global ID attribute that identifies a graph node directly further comprises attaching the new graph node to a transition that has the same name as the particular element and is leaving a graph node identified by a parent element of the particular tree element.

20. A method as defined in claim 16, wherein attaching a referenced graph node to a directed edge that has a name that is the same as a name of the particular tree element further comprises attaching the new graph node to a transition that has the same name as the particular tree element and is leaving a graph node identified by a parent element of the particular tree element.

21. A method as defined in claim 16, wherein examining a particular element led to by the particular transition further comprising determining if the particular element is represented by a particular pair in the table.

22. A data structure for representing graph data as a tree, the data structure comprising:
one or more elements, wherein content of each element is optional;
a first attribute reference to a global ID attribute that is optional; and
a second attribute reference to a global ref attribute that is optional.

23. A data structure as defined in claim 22, further comprising an element content sequence.

24. A data structure as defined in claim 22, wherein the global ID attribute and the global ref attribute are mutually exclusive.

25. A data structure as defined in claim 24, wherein the data structure does not does not include a global ID attribute if the data structure includes a global ref attribute.

26. A data structure as defined in claim 24, wherein the data structure does not includes the global ref attribute if the data structure includes a global ID attribute.

27. A schema for defining an Infoset that contains graph data, the schema comprising:
one or more complexTypes, wherein at least one complexType includes:
a content sequence that includes one or more elements, each element having a type; and
a global ID attribute and a global ref attribute that are mutually exclusive such that use of the global attribute excludes use of the global ref attribute and use of the global ref attribute excludes use of the global ID attribute for a particular instance of the schema.

28. A schema as defined in claim 27, wherein each complexType has a name.

29. A schema as defined in claim 27, wherein a minimum occurrence constraint of the content sequence is zero.

30. A schema as defined in claim 29, wherein the content sequence includes one or more elements, wherein content of each element is optional.

31. A schema as defined in claim 27, wherein a use constraint of the global ID attribute is optional.

32. A schema as defined in claim 27, wherein a sue constraint of the global ref attribute is optional.

33. A schema as defined in claim 27, wherein an element declaration may be marked nil and a declaration nil attribute may be true.

34. A computer program product for implementing a method for converting a graph to a tree, the computer program product comprising:
a computer readable having computer executable instructions for implementing the method, the method comprising:
traversing a directed graph such that each node is visited at least once;
when a node in the directed graph is visited, determining if the node is being visited for the first time;
creating an element in a tree if the node is being visited for the first time, wherein an edge leading to the node is assigned to the element and the element is marked with a global ID attribute; and
if a node in the directed graph is being visited for a time that is not the first time, adding an element to the tree that is marked with a global ref attribute to correspond to the node.

35. A computer program product as defined in claim 34, the method further comprising constructing a table correlating nodes to global ID attributes, wherein an entry is made into the table each time that a node is visited for the first time.

36. A computer program product as defined in claim 35, the method further comprising:
assigning a unique ID to a node of a node is not in the table;
marking an element representing the node with the global ID attribute whose value is the unique ID of the node; and
storing data in the node in a tree element.

37. A computer program product as defined in claim 35, the method further comprising:
marking an element that leads to a particular node with a particular global ref attribute if the particular node is in the table; and
not traversing transitions leaving the particular node.
